(19) United States
(12) Patent Application Publication
(10) Pub. No.: US 2004/0036890 A1
(43) Pub. Date: Feb. 26, 2004

(54) Methods and devices for measuring a surface profile of an optical element

(75) Inventors: Shigeru Nakayama, Kawasaki-shi (JP); Yuichi Takigawa, Kawasaki-shi (JP); Takashi Gemma, Tokyo (JP)

Correspondence Address: KLARQUIST SPARKMAN, LLP, One World Trade Center, Suite 1600, 121 S.W. Salmon Street, Portland, OR, 97204, US

(73) Assignee: Nikon Corporation

(21) Appl. No.: 10/003,042

(22) Filed: Nov. 13, 2001

(30) Foreign Application Priority Data
Nov. 14, 2000 (JP) 2000-346505
Nov. 1, 2001 (JP) 2001-336084

(51) Int. Cl. G01B 9/02

(52) U.S. Cl. 356/513

(57) ABSTRACT

Methods are disclosed for measuring the surface profile of a “test surface” of an object such as an optical element, which can be a lens or reflective element (mirror). The “test surface” can have any of various profiles, including (but not limited to) spherical or aspherical. In a method embodiment, respective phase distributions of interference fringes, produced by interference of a reference light and light reflected from the test surface, and interference of the reference light and a respective light reflected from at a reference standard and/or a verification standard. A profile difference is computed from the respective phase distributions of interference fringes produced with respect to the test surface and the reference standard and/or verification standard. The profile difference is corrected, wherein the corrected profile difference is expressed as respective rotation-symmetry-error and rotation-asymmetry-error components, and the rotation-symmetry-error component is expressed as respective high-order and low-order components. The high-order component is computed by extraction from a difference between two difference phase distributions of interference fringes.

### FIELD

This disclosure relates to methods and devices for measuring the surface profile of objects with high accuracy. More specifically, the disclosure pertains to methods and devices for measuring the surface profile of optical elements such as lenses and mirrors, including such elements having aspherical surfaces.

### BACKGROUND

In recent years, in conjunction with the demand for increasingly higher-accuracy optical devices, there has been a trend toward high accuracy and precision in optical elements such as the lenses and mirrors as used in these instruments. In addition to higher accuracy and precision being required in optical elements having spherical surfaces, increased accuracy and precision also is being demanded in aspheric elements and in surface-profile-measurement devices used for measuring spherical and aspherical surface profiles.

If, with respect to an item having an aspheric surface to be measured, the deviation of the aspheric surface from the closest spherical surface is small (this deviation is termed herein the “asphere-sphere difference”), then measurements of the aspherical surface can be performed using an interferometer such as a Fizeau interferometer normally used for spherical-surface measurements. Alternatively, the measurements can be performed using a point-diffraction interferometer (see Japan Kôkai Patent Publication No. Hei 2-228505) that utilizes a diffraction wavefront emanating as a reference wavefront from a pinhole. However, with aspheric surfaces of which the asphere-sphere difference is large, the radius of curvature varies greatly with radial position on the surface. If a Fizeau interferometer or point-diffraction interferometer is used for measuring such an aspheric surface, the interferogram reveals respective regions in which the interference-fringe interval is broad and in which the interference-fringe interval is very small. Consequently, meaningful measurements are not possible.

Also, if a Fizeau interferometer configured for measuring an aspheric surface is used for measuring an aspheric surface, an aspheric-surface standard is required. However, it is difficult to produce an aspheric-surface standard of which the surface profile has a sufficiently high accuracy for use as a standard.

### SUMMARY

In view of the problems associated with conventional methods and devices, as summarized above, the present invention provides methods and devices for measuring a surface profile of a “test surface” (surface of interest) of an object such as an optical element, such as a spherical or an aspherical lens, with high accuracy. The methods and devices can be incorporated into methods for manufacturing spherical and/or aspherical elements with high accuracy and that include one or more steps in which a surface of such an element is measured with high accuracy.

According to one method embodiment, a phase distribution of a first set of interference fringes, with respect to the test surface, is measured. The first set of interference fringes is produced by interference of a measurement light beam, reflected from the test surface, and a reference light beam having a prescribed wavefront profile. A phase distribution of a second set of interference fringes, with respect to a reference standard, also is measured. The second set is produced by interference of light reflected from the reference standard and the reference light beam. A phase distribution of a third set of interference fringes, with respect to a verification standard, also is measured. The third set is produced by interference of light reflected from the verification standard and the reference light beam. A profile difference is calculated from the phase distribution of the first set of interference fringes and the phase distribution of the second set of interference fringes. The profile difference is corrected, from “design-mandated” data (i.e., as-designed data corresponding to an ideal surface) for the reference standard, of the test surface measured with respect to the reference standard. The corrected profile difference is expressed as a respective rotation-symmetry-error component and a respective rotation-asymmetry-error component. The rotation-symmetry-error component is expressed as a high-order component of rotation-symmetry error and a low-order component of rotation-symmetry error. The high-order component of rotation-symmetry error is computed by extracting the high-order component of rotation-symmetry error from a difference between the phase distribution of interference fringes with respect to the verification standard and the phase distribution of interference fringes with respect to the reference standard.

In the foregoing method, the verification standard can be a reflection-type diffraction optical element or an element group comprising a reflection-type diffraction optical element and an optical element.

The low-order component of rotation-symmetry error desirably is one or more terms, of an even-numbered exponential series pertaining to coordinates on the test surface, of fourth order or less. Alternatively, the low-order component of rotation-symmetry error is one or more terms, of an even-numbered exponential series pertaining to coordinates on the test surface, of sixth order or less.

The test surface can be, by way of example, spherical or aspherical.

Another method embodiment is similar to the method summarized above, but includes the step of correcting the high-order component of rotation-symmetry error from the design-mandated data for the verification standard.

In another method embodiment a phase distribution of a first set of interference fringes, with respect to the test surface, is measured. The first set is produced by interference of a measurement light beam, reflected from the test surface, and a reference light beam having a prescribed wavefront profile. A phase distribution of a second set of interference fringes, with respect to a prescribed verification standard, also is measured. The second set is produced by interference of light reflected from the verification standard and the reference light beam. A profile difference is computed from the design-mandated data for the test surface. The profile difference includes a rotation-symmetry-error component and a rotation-asymmetry-error component. The rotation-symmetry-error component includes both high-order and low-order components of rotation-symmetry error. The high-order component is computed by extracting the high-order component from a difference between the phase distribution of the second set of interference fringes and the phase distribution of the first set of interference fringes.

Yet another method embodiment is similar to the method summarized in the preceding paragraph, but also includes the step of correcting the high-order component from the design-mandated data for the verification standard.

The foregoing and other features and advantages of the invention will be more readily apparent from the following detailed description, which proceeds with reference to the accompanying drawings.

### BRIEF DESCRIPTION OF THE DRAWINGS

FIG. 1 is a schematic diagram of a surface-profile measurement apparatus according to a first representative embodiment.

FIG. 2 is a plot of profile-measurement error obtained in a situation in which a 5 μm error was present between a spherical lens and a reflective phase-zone plate.

FIG. 3 is a block diagram of a surface-profile-measurement method as performed using the apparatus according to a first representative embodiment.

FIG. 4 is a block diagram of a surface-profile-measurement method according to a second representative embodiment.

FIG. 5 is a schematic diagram of a surface-profile-measurement apparatus according to a third representative embodiment.

### DETAILED DESCRIPTION

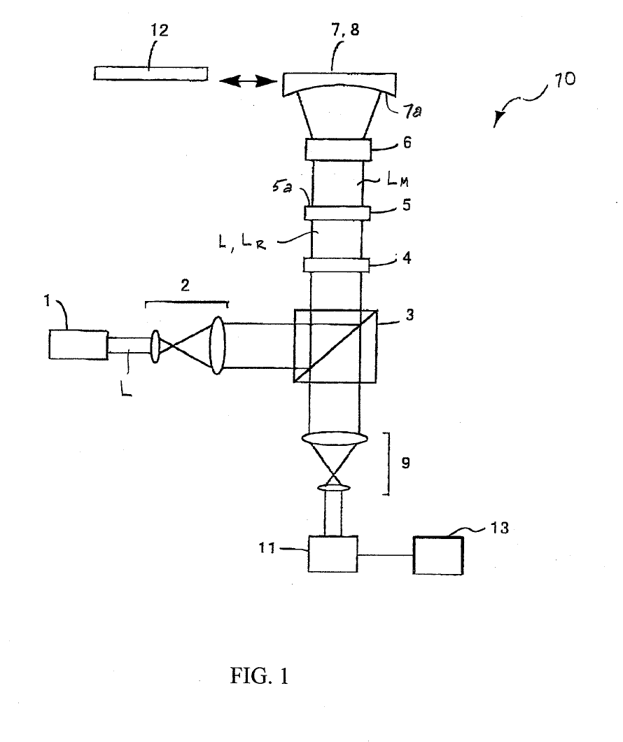

A first representative embodiment of a surface-profile-measurement device 10 is depicted in FIG. 1. The device 10 comprises a light source 1, a beam-expander 2, a polarizing beamsplitter (“PBS”) 3, a quarter-wavelength plate (quarter-wave retarder) 4, a Fizeau member 5, a null optical component 6, a “reference standard” 8, a beam-reducer 9, a two-dimensional image detector 11, a “verification standard” 12, and a computer 13. Item 7 is the sample element (e.g., an aspheric lens) having a “test surface” 7a (e.g., aspheric surface) to be measured. The reference standard 8 is a standard prototype of the sample element 7. A linearly polarized light beam L is emitted from the light source 1. The diameter of the beam L is increased by the beam-expander 2, and the beam L is incident to the PBS 3. The plane of polarization of the beam L is selected so that the beam L is reflected by the PBS 3.

Light of the beam L reflected by the PBS 3 passes through the quarter-wavelength plate 4 and is incident to the Fizeau member 5. The Fizeau member 5 splits the incident light into a measurement light L_{M}, that passes through a reference plane (Fizeau surface) 5a of the Fizeau member 5, and a reference light L_{R} reflected by the reference plane 5a.

The measurement light L_{M} passes through the null optical component 6, which (in this embodiment) confers an aspheric wavefront to the measurement light LM as the measurement light L_{M} passes through the null optical component 6. The measurement light L_{M} is reflected by the test surface 7a, the reference standard 8, or the verification standard 12 arranged at respective prescribed positions. (The sample element 7, reference standard 8, and verification standard 12 are measured in turn in this embodiment.) The reflected measurement light L_{M} returns back through the null optical component 6, the Fizeau member 5, and the quarter-wavelength plate 4 to the PBS 3. Thus, during its trip to and from the test surface 7a, the reference standard 8, or the verification standard 12, the measurement light L_{M} passes through the quarter-wavelength plate 4 twice, which causes the plane of polarization of the measurement light L_{M} to be rotated 90 degrees before it returns through the PBS 3. The diameter of the beam of measurement light L_{M} returning through the PBS 3 is reduced, by passage through the beam-reducer 9, for impingement on the two-dimensional image detector 11.

As noted above, light of the beam L that is reflected by the Fizeau member 5 is used as reference light L_{R}. The returning reference light L_{R} passes through the quarter-wavelength plate 4, the PBS 3, and the beam-reducer 9, and is incident to the two-dimensional image detector 11. The image detector 11 detects interference fringes produced by interference of the measurement light L_{M} with the reference light L_{R}.

The apparatus of FIG. 1 is configured such that the aspheric wavefront produced by the null optical component 6 is normally incident at all locations on the aspheric test surface 7a. Thus, the measurement beam LM, after reflecting from the test surface 7a and now propagating in the reverse direction along its approach route, substantially retains the wavefront profile it had when traveling along its approach route toward the test surface 7a. Accordingly, the wavefront profile of the returning measurement beam LM is substantially a plane wave as it interferes with the reference light L_{R}. By analyzing the interference pattern produced by interference of the measurement and reference lights, it is possible to measure the difference in the surface profile of the test surface 7a versus the wavefront profile of the measurement light L_{M} at the test surface 7a.

The verification standard 12 desirably is a reflective phase-zone plate that produces almost entirely low-order measurement errors even if a magnification error exists in its writing pattern. The verification standard 12 is used for verifying the accuracy of the reference standard 8. Specifically, the rotation-symmetry-error component (a high-order error component) of the reference standard 8 is verified with high accuracy using the verification standard 12.

The effect of errors in the writing pattern on measurements performed using the device of FIG. 1 increases with corresponding decreases in the pattern pitch of the verification standard 12 (reflective phase-zone plate). The reflective phase-zone plate can be combined with a spherical lens, allowing the pattern pitch on the reflective phase-zone plate to be increased. With such a combination, errors associated with the radius of curvature and the center thickness of the spherical lens, as well as the axial distance between the spherical lens and the reflective phase-zone plate, become actual measurement errors. Since these errors are almost entirely low-order components, high-order components can be verified with high accuracy.

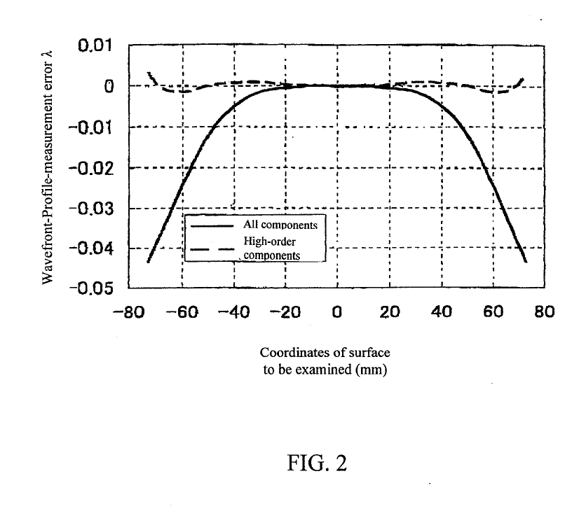

This situation is explained using FIG. 2 as an example. FIG. 2 is a plot of wavefront-profile-measurement errors (i.e., differences in the phase distribution of interference fringes obtained under an ideal condition, in which all surfaces are as design-mandated, versus interference fringes obtained under an actual condition, characterized by deviation from the ideal condition). In this instance, the actual condition includes a 5-μm error in the distance between the spherical lens and the reflective phase-zone plate. The solid-line curve is a plot of all components (i.e., both low-order and high-order components) of a rotation-symmetry error, and the dashed-line curve is of only the high-order components of the rotation-symmetry error (i.e., respective low-order components removed). Hence, FIG. 2 shows that a distance between the spherical lens and the reflective zone plate does not affect the high-order components of the rotation-symmetry error. This property is characteristic not only of space-interval errors but also of curvature-radius errors and center-thickness errors of the spherical lens.

As noted above, a reflective phase-zone plate (normally having a planar reflective surface) typically is used as the verification standard 12. However, whenever the incident wavefront corresponds to a design-mandated profile of the test surface 7a, reflection of the incident wavefront from the verification standard may be obtained in a manner serving to preserve the same wavefront. In such a situation, the phase-zone plate may be combined with, e.g., a spherical lens to provide the verification standard 12 with a spherical reflective surface. In such an instance, since the only effects on wavefront-profile-measurement error caused by curvature-radius errors, center-thickness errors, and space-interval errors of components of the verification standard 12 are low-order components, the high-order components of rotation-symmetry error of the reference standard 8 can be determined with high accuracy.

The null optical component 6 is configured to perform conversion of a wavefront that, as incident on the aspheric test surface 7a, is substantially perpendicular to and at the same phase with respect to the test surface 7a or to the reference standard 8.

The Fizeau member 5 is mounted on a holding mechanism (not shown) that desirably is a piezoelectric element. Actuation of the piezoelectric element causes the Fizeau member 5 to be moved slightly in the optical-axis direction. As a result of such motion, the phase distribution of interference fringes produced by light from the sample element 7, the reference standard 8, and the verification standard 12 can be measured with high accuracy using the known phase-shift interference method.

Similarly, any of the sample element 7, the reference standard 8, and the verification standard 12 can be mounted on a holding mechanism (not shown) comprising a respective piezoelectric element. Actuation of the piezoelectric element causes the sample element 7, the reference standard 8, and/or the verification standard 12 to be moved slightly in the optical-axis direction. As a result of such motion, the phase distribution of interference fringes produced by light from the sample element 7, the reference standard 8, and the verification standard 12 can be measured with high accuracy using the known phase-shift interference method.

The beam-reducer 9 forms an image of the aspherical test surface 7a on the two-dimensional image detector 11. Hence, the beam-reducer 9 desirably is configured with as low a distortion aberration as possible so as to provide accurate measurements of the profile of the test surface 7a.

By using design-mandated data and actual measured data concerning distortion aberrations for correcting coordinates of interference fringes produced by the FIG. 1 device, it is possible to correlate surface coordinates on the aspherical test surface 7a accurately with respective coordinates on the two-dimensional image detector 11.

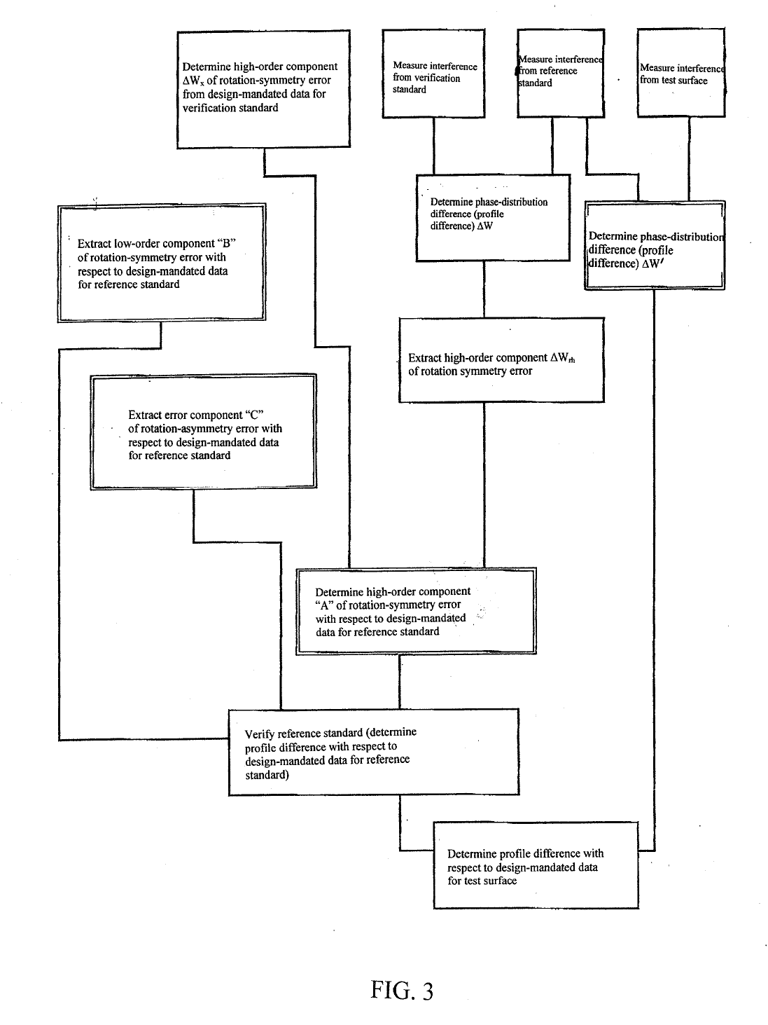

Key steps in a method for measuring an aspherical surface profile of a test surface 7a, according to a first representative embodiment, are diagrammed in FIG. 3. For purposes of describing the method, the “profile difference” of the test surface 7a (i.e., deviation in profile of an actual test surface 7a from the corresponding design-mandated surface) of an aspherical sample element 7 is regarded as consisting of a rotation-symmetry-error component and a rotation-asymmetry-error component. The rotation-symmetry-error component is expressed as the sum of two components: a component that varies gradually with respect to the coordinates on the test surface 7a (referred to below as the “low-order component”) and a remainder component (referred to below as the “high-order component”).

The low-order component (6) of the rotation-symmetry error is expressed as second-order and fourth-order functions of a coordinate y on the test surface 7a:

δ(y)=a₂·y²+a₄·y⁴

wherein a₂ and a₄ are respective constants. Alternatively, the low-order component can be defined by an expression including up to a sixth-order function or by a known Zernike polynomial low-order function, δ′(p)=b₀+b₁(2ρ²−1)+b₂(6Σ⁴−6Σ²+1), wherein p is a radial coordinate, and the b₀, b₁, and b₂ terms are constants. The profile difference of the actual aspherical test surface 7a from the corresponding design-mandated surface profile is measured using a corresponding reference standard 8 for the aspherical test surface.

Specifically, the difference in phase distribution ΔW′ of the aspherical test surface 7a with respect to the reference standard 8 is computed by comparing the phase distribution of interference fringes produced by the aspherical test surface 7a to the phase distribution of interference fringes produced by the reference standard 8. (A known phase-shift interference method can be used to measure the phase distributions.) Then, the profile difference of the test surface 7a with respect to the corresponding design-mandated aspheric profile of the test surface 7a is computed by correcting certain profile-error components (“A”, “B”, and “C”, discussed below) with respect to the reference standard 8.

The profile difference ΔW′ of the test surface 7a with respect to the reference standard 8 is computed by the computer 13 of the profile-measurement apparatus 10. (For such a calculation any error corrections pertaining to the reference standard 8 can be input to the computer 13 in advance.) The profile difference of the test surface 7a is measured relative to the design-mandated profile of the corresponding reference standard 8 (i.e., for an aspheric element). The profile-error components of the reference standard 8 are: “A” (high-order component of rotation-symmetry error), “B” (low-order component of rotation-symmetry error), and “C” (rotation-asymmetry error).

First, the high-order component of rotation-symmetry error (component “A”) is determined from deviations of the reference standard 8 from the phase distribution of the verification standard 12 by the following method:

(a) The verification standard 12 is placed at a prescribed position in the profile-measurement apparatus 10.

(b) The phase distribution W_{A} of the verification standard 12 is measured, e.g., using a known phase-shift interference technique.

(c) The reference standard 8 is placed at a prescribed holding position in the profile-measurement apparatus 10.

(d) The phase distribution W_{B} of the reference standard 8 is measured.

(e) The profile difference ΔW of the reference standard 8 relative to the verification standard 12 is computed, wherein ΔW=W_{B}−W_{A}. A corresponding rotation-symmetry-error component (ΔWᵣ) is extracted by rotational averaging from the phase difference ΔW. “Fitting” of ΔWᵣ is performed using the δ(y) function noted above, allowing separation into corresponding second-order and fourth-order components (collectively low-order components) and remainder components (high-order components). The resulting high-order components of rotation-symmetry error are denoted ΔWᵣₕ.

(f) The high-order component ΔWᵣₕ of rotation-symmetry error of the verification standard 12, relative to the design-mandated data for the verification standard 12, is corrected by the high-order component ΔWᵣₕ of rotation symmetry to yield the high-order component “A”, as follows:

A=ΔWᵣₕ+ΔWₓ

The ΔWₓ term is computed from the results of measurements of any irregularities of the pattern plane, and of diffraction-pattern-element positions thereon, of the verification standard. If the verification standard 12 is a reflective phase-zone plate, these measurements can be obtained using a coordinate-measuring device.

Second, the low-order component “B” of rotation-symmetry error is measured using a stylus-type of profile-measurement device to measure the surface of the reference standard 8. A corresponding rotation-symmetry-error component (ΔW_{R}) is extracted from the measurement data, and “fitting” is performed using the δ(y) function noted above, allowing separation of second-order and fourth-order components (collectively low-order components) and remainder components (high-order components).

Third, the rotation-asymmetry-error component “C” is determined at high accuracy by averaging the respective phase distributions obtained each time the reference standard 8 is rotated a unit rotation angle θ from a reference position.

Fourth, the profile difference of the reference standard 8 with respect to the design-mandated data for the reference standard 8 is determined as the sum of the components “A”, “B”, and “C”.

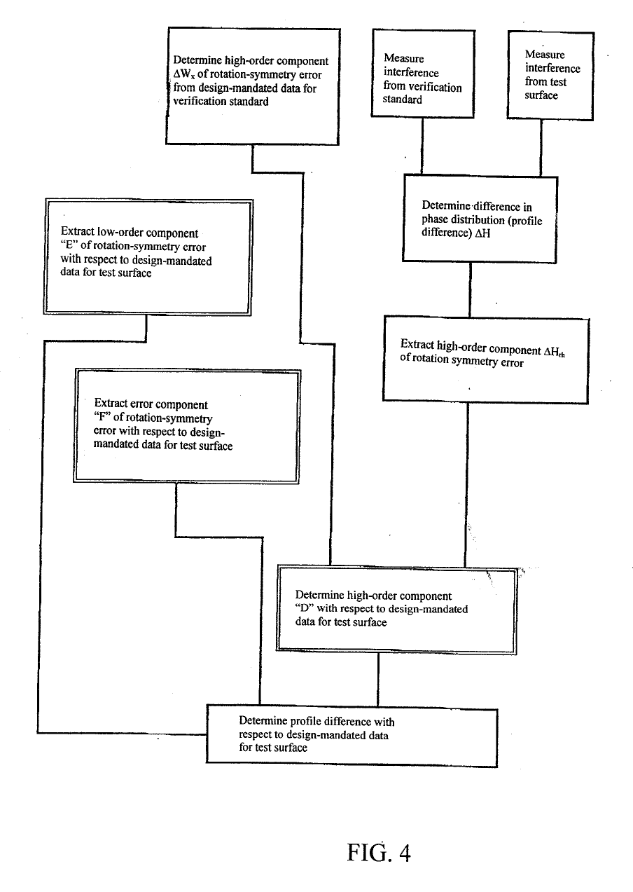

Key steps in a method for measuring a profile (especially an aspheric profile), according to a second representative embodiment, are described below with reference to FIG. 4.

As discussed above, the profile difference of the test surface 7a (i.e., profile difference of the test surface 7a from the design-mandated profile for the test surface 7a) consists of a rotation-symmetry-error component and a rotation-asymmetry-error component. In this case, the rotation-symmetry-error component consists of a corresponding high-order component (“D”) and a corresponding low-order component (“E”).

The high-order component “D” of rotation-symmetry error is measured using the verification standard 12. Specifically, this high-order component is obtained by correcting the high-order component of rotation-symmetry error (from design-mandated data for the verification standard 12) to the high-order component of rotation-symmetry error for the profile difference of the test surface 7a relative to the verification standard 12.

First, the high-order component “D” of the rotation-symmetry error is determined as follows:

(a) The verification standard 12 is placed in the prescribed holding position in the aspheric-profile-measurement apparatus 10.

(b) The phase distribution W_{A} of the verification standard 12 is measured, e.g., using a known phase-shift-interference technique.

(c) The sample element 7 is placed in the prescribed holding position in the aspheric-profile-measurement apparatus 10.

(d) The phase distribution W_{C} of the test surface 7a of the sample element 7 is measured. (e) The profile difference ΔH of the test surface 7a with respect to the verification standard 12 is computed, wherein ΔH=W_{C}−W_{A}. A corresponding rotation-symmetry-error component (ΔHᵣ) is extracted from the profile difference ΔH by rotational averaging. “Fitting” of ΔHᵣ is performed using the δ(y) function noted above, allowing separation into corresponding second-order and fourth-order components (collectively low-order components) and corresponding remainder components (high-order components). The resulting high-order components of the rotation-symmetry error are denoted ΔHᵣₕ.

(f) The high-order component ΔWₓ of rotation-symmetry error relative to the design-mandated data for the verification standard 12 is corrected by the high-order component ΔHᵣₕ to yield the high-order error component “D”, as follows:

D=ΔHᵣₕ+ΔWₓ

If a reflecting phase-zone plate is used as the verification standard 12, then the high-order component ΔWₓ can be computed from the results of measurements performed of the phase-zone plate. These measurements are of any profile irregularities of the diffraction-pattern plane and of the positions of diffraction-pattern elements as performed using a coordinate-measuring device.

Second, the low-order component “E” of rotation-symmetry error is determined from data concerning the profile difference of the test surface 7a relative to design-mandated data for the test surface 7a. The test surface 7a can be measured using a stylus-type profile-measurement apparatus. Rotation-symmetry-error components are extracted from the respective measured values. “Fitting” is performed using the δ(y) function noted above, allowing separation into corresponding second-order and fourth-order components (collectively low-order components) and corresponding remainder components (high-order components).

Third, the rotation-asymmetry-error component (“F”) is obtained from data concerning the profile difference of the test surface 7a relative to the design-mandated data for the test surface 7a. These determinations are made with high accuracy by averaging the respective phase distributions obtained each time the sample element 7 is rotated a unit rotation angle θ from a reference position.

Fourth, the profile difference of the test surface 7a relative to the design-mandated data for the test surface 7a is determined as the sum of the components “D”, “E”, and “F”.

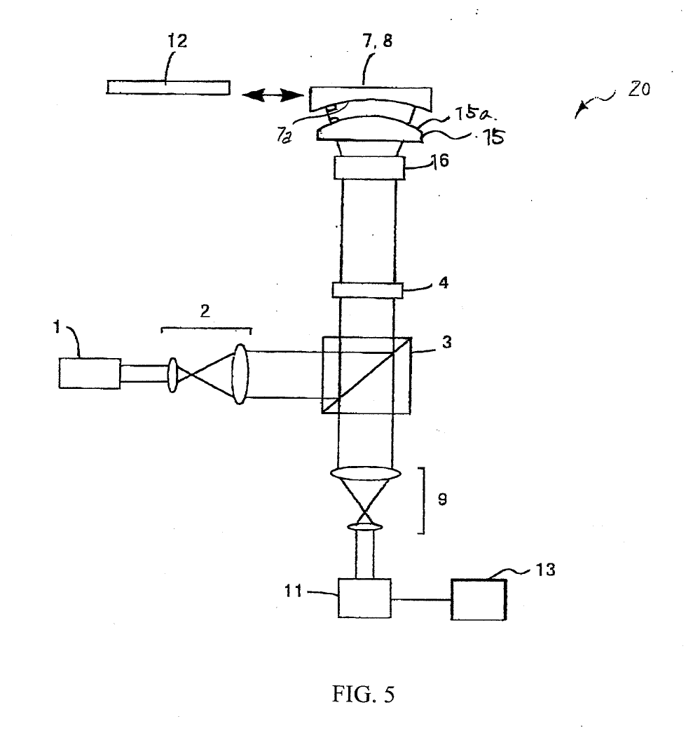

An aspheric-profile-measurement apparatus 20 according to a third representative embodiment is described below with reference to FIG. 5, in which components that are similar to respective components in FIG. 1 have the same reference numerals and are not described further below. In the apparatus 20 a Fizeau member 15 is situated between an optical component 16 and the sample element 7. The optical component 16 converts the wavefront of a perpendicularly incident light beam to a wavefront that is incident perpendicularly and at the same phase at all locations on an aspheric Fizeau surface 15a of the Fizeau member 15. Thus, light that has passed through the Fizeau surface 15a is incident perpendicularly and at the same phase at all locations on the test surface 7a.

In a first step of a method performed using the apparatus of FIG. 5, the high-order component “D” of rotation-symmetry error (see above) of the test surface 7a is measured, as follows:

(a) The verification standard 12 is placed at the prescribed holding position in the aspheric-profile-measurement apparatus 20.

(b) The phase distribution W_{D} of the verification standard 12 is measured, e.g., using a known phase-shift-interference technique.

(c) The sample element 7 is placed at the prescribed holding position in the aspheric-profile-measurement apparatus 20.

(d) The phase distribution W_{E} of the test surface 7a is measured.

(e) The profile difference ΔH of the test surface 7a relative to the verification standard 12 is computed, wherein ΔH=W_{E}−W_{D}. The corresponding rotation-symmetry-error component (ΔHᵣ) is extracted from this profile difference ΔH. “Fitting” of ΔHᵣ is performed using the δ(y) function noted above, allowing separation into corresponding second-order and fourth-order components (collectively low-order components) and remaining components (high-order components). The resulting high-order components of the rotation-symmetry error are denoted ΔHᵣₕ.

(f) The high-order component ΔWₓ of rotation-symmetry error relative to the design-mandated data for the verification standard 12 (see above) is corrected by the high-order component ΔHᵣₕ to yield the high-order component “D”, as follows:

D=ΔHᵣₕ+ΔWₓ

If a reflecting phase-zone plate is used as the verification standard 12, then the high-order component ΔWₓ can be computed from the results of measurements performed of profile irregularities of the pattern plane and of the positions of diffraction-pattern elements on the verification standard using, e.g., a coordinate-measuring device.

Second, the low-order component “E” of rotation-symmetry error (for the profile difference ΔH) is determined from data concerning the profile difference of the test surface 7a relative to design-mandated data for the test surface 7a. The phase distribution W_{E} is composed of the profile difference relative to design-mandated data for the aspheric Fizeau surface 15a and the profile difference relative to the design-mandated data for the test surface 7a.

The rotation-symmetry-error component of the ΔH profile difference is extracted from the phase distribution W_{E} of the test surface 7a by rotational averaging. “Fitting” of the rotation-symmetry-error component is performed using the δ(y) function noted above, allowing separation into corresponding low-order components and corresponding high-order components. The corresponding low-order component ΔKᵣₗ of rotation-symmetry error is extracted by rotational averaging.

Rotation-symmetry error ΔJᵣ of the aspheric Fizeau surface 15a is measured using a stylus-type of profile-measuring apparatus. The low-order component ΔJᵣₗ of rotation-symmetry error ΔJᵣ is extracted from the measured ΔJᵣ data by rotational averaging. “Fitting” of the rotation-symmetry-error component is performed using the δ(y) function noted above, allowing separation into corresponding second-order and fourth-order components (collectively corresponding low-order components) and remaining components (corresponding high-order components).

The low-order component “E” of rotation-symmetry error (of the test surface 7a relative to the design-mandated data for the test surface 7a) is computed by correcting the low-order component ΔJᵣₗ by the low-order component ΔKᵣₗ, as follows:

E=ΔKᵣₗΔJᵣₗ

Third, the rotation-asymmetry-error component “F” (of the profile difference of the test surface 7a relative to the design-mandated data for the test surface 7a) is computed by correcting the rotation-asymmetry-error component of the aspheric Fizeau surface 15a by the rotation-asymmetry-error component extracted from the phase distribution W_{E}.

The rotation-asymmetry-error component of the aspheric Fizeau surface 15a is measured by averaging the respective phase distributions obtained each time the Fizeau member 15 is rotated from a reference position by unit rotation angle θ.

Fourth, the profile difference of the test surface 7a relative to the design-mandated data for the test surface 7a is the sum “D”+“E”+“F”.

The foregoing description is set forth in the context of measuring an aspheric test surface. This is not intended to be limiting. It will be understood that the principles described above are equally applicable to measurements performed on a spherical test surface.

The profile-measurement embodiments according to this invention have especial application in processes for manufacturing lenses with extremely high accuracy and precision.

After obtaining measurements of the profile difference of the test surface 7a relative to design-mandated data for the test surface 7a, using methods as described herein, corresponding error corrections can be made during the grinding and polishing processes applied to making corresponding optical elements. After completing grinding and polishing of an optical element, the profile difference again can be determined using methods as described herein. Thus, the surface profile of the sample element 7 can be fabricated to desired tolerances.

Whereas the invention has been described in connection with multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A method for measuring a surface profile of a test surface of an object, comprising:
measuring a phase distribution of interference fringes, with respect to the test surface, produced by interference of a measurement light beam, reflected from the test surface, and a reference light beam having a prescribed wavefront profile;
measuring a phase distribution of interference fringes, with respect to a reference standard, produced by interference of light reflected from the reference standard and the reference light beam;
measuring a phase distribution of interference fringes, with respect to a verification standard, produced by interference of light reflected from the verification standard and the reference light beam;
computing a profile difference from the phase distribution of interference fringes produced with respect to the test surface, and the phase distribution of interference fringes produced with respect to the reference standard; and
correcting the profile difference, from design-mandated data for the reference standard, of the test surface measured with respect to the reference standard;
wherein (i) the corrected profile difference is expressed as a respective rotation-symmetry-error component and a respective rotation-asymmetry-error component, (ii) the rotation-symmetry-error component is expressed as a high-order component of rotation-symmetry error and a low-order component of rotation-symmetry error, and (iii) the high-order component of rotation-symmetry error is computed by extracting the high-order component of rotation-symmetry error from a difference between the phase distribution of interference fringes with respect to the verification standard and the phase distribution of interference fringes with respect to the reference standard.

2. The method of claim 1, wherein the verification standard is a reflection-type diffraction optical element or an element group comprising a reflection-type diffraction optical element and an optical element.

3. The method of claim 1, wherein the low-order component of rotation-symmetry error is one or more terms, of an even-numbered exponential series pertaining to coordinates on the test surface, of fourth order or less.

4. The method of claim 1, wherein the low-order component of rotation-symmetry error is one or more terms, of an even-numbered exponential series pertaining to coordinates on the test surface, of sixth order or less.

5. The method of claim 1, wherein the test surface is an aspheric surface.

6. A method for manufacturing an optical element, comprising a surface-profile measurement method as recited in claim 1 for measuring a profile of a surface of the optical element.

7. A method for measuring a surface profile of a test surface of an object, comprising:
measuring a phase distribution of interference fringes, with respect to the test surface, produced by interference of a measurement light beam, reflected from the test surface, and a reference light beam having a prescribed wavefront profile;
measuring a phase distribution of interference fringes, with respect to a reference standard, produced by interference of light reflected from the reference standard and the reference light beam;
measuring a phase distribution of interference fringes, with respect to a verification standard, produced by interference of light reflected from the verification standard and the reference light beam;
computing a profile difference from the phase distribution of interference fringes produced with respect to the test surface and the phase distribution of interference fringes produced with respect to the reference standard; and
correcting the profile difference, from design-mandated data for the reference standard, of the test surface measured with respect to the reference standard;
wherein (i) the corrected profile difference is expressed as a respective rotation-symmetry-error component and a respective rotation-asymmetry-error component, (ii) the rotation-symmetry-error component is expressed as a high-order component of rotation-symmetry error and a low-order component of rotation-symmetry error; and (iii) the high-order component of rotation-symmetry error is computed by extracting the high-order component of rotation-symmetry error from a difference between the phase distribution of interference fringes with respect to the verification standard and the phase distribution of interference fringes with respect to the reference standard, and correcting the high-order component of rotation-symmetry error from the design-mandated data for the verification standard.

8. A method for measuring a surface profile of a test surface of an object, comprising:
measuring a phase distribution of interference fringes, with respect to the test surface, produced by interference of a measurement light beam, reflected from the test surface, and a reference light beam having a prescribed wavefront profile;
measuring a phase distribution of interference fringes, with respect to a prescribed verification standard, produced by interference of light reflected from the verification standard and the reference light beam; and
computing a profile difference from the design-mandated data for the test surface, the profile difference including a rotation-symmetry-error component and a rotation-asymmetry-error component, the rotation-symmetry-error component including a high-order component of rotation-symmetry error and a low-order component of rotation-symmetry error, the high-order component of rotation-symmetry error being computed by extracting said high-order component from a difference between the phase distribution of interference fringes with respect to the verification standard and the phase distribution of interference fringes with respect to the test surface.

9. The method of claim 8, wherein the verification standard is a reflection-type diffraction optical element or an element group comprising a reflection-type diffraction optical element and an optical element.

10. The method of claim 8, wherein the low-order component of rotation-symmetry error is one or more terms, of an even-numbered exponential series pertaining to coordinates on the test surface, of fourth order or less.

11. The method of claim 8, wherein the low-order component of rotation-symmetry error is one or more terms, of an even-numbered exponential series pertaining to coordinates on the test surface, of sixth order or less.

12. The method of claim 8, wherein the test surface is an aspheric surface.

13. A method for manufacturing an optical element, comprising a surface-profile measurement method as recited in claim 8 for measuring a profile of a surface of the optical element.

14. A method for measuring a surface profile of a test surface of an object, comprising:
measuring a phase distribution of interference fringes, with respect to the test surface, produced by interference of a measurement light beam, reflected from the test surface, and a reference light beam having a prescribed wavefront profile;
measuring a phase distribution of interference fringes, with respect to a verification standard, produced by interference of light reflected from the verification standard and the reference light beam;
computing a profile difference from the design-mandated data for the test surface, the profile difference including a rotation-symmetry-error component and a rotation-asymmetry-error component, the rotation-symmetry-error component including a high-order component of rotation-symmetry error and a low-order component of rotation-symmetry error, the high-order component being computed by extracting said high-order component from a difference between the phase distribution of interference fringes with respect to the verification standard and the phase distribution of interference fringes with respect to the test surface, and correcting the high-order component from the design-mandated data for the verification standard.
